(19) United States
(12) Patent Application Publication
(10) Pub. No.: US 2016/0292796 A1
(43) Pub. Date: Oct. 6, 2016

(54) BEVERAGE INVENTORY SYSTEMS AND METHODS

(71) Applicant: Vessel Innovations Inc., Mississauga (CA)

(72) Inventors: Jean-Andre Furlotte, Toronto (CA); Deeson Shukkarbhai Patel, Brampton (CA); Keith Brian Lobo, Toronto (CA); Keegan James Lobo, Mississauga (CA); Boniface Jeyanthan Anjalo Yogendran, Toronto (CA)

(73) Assignee: Vessel Innovations Inc.

(21) Appl. No.: 15/086,564

(22) Filed: Mar. 31, 2016

Related U.S. Application Data
(60) Provisional application No. 62/141,967, filed on Apr. 2, 2015.

(51) Int. Cl. G06Q 50/12; G01F 23/296; G06Q 10/08

(52) U.S. Cl. CPC G06Q 50/12; G06Q 10/087; G01F 23/296

(57) ABSTRACT

A beverage inventory system includes a level sensing subsystem configured to interface with a beverage container and to produce one or more electronic signals based on a level of liquid within the container. The system also includes processing structure configured to receive the one or more electronic signals and to compute volume of liquid within the container based on a corresponding signal-volume relationship.

### CROSS-REFERENCE TO RELATED APPLICATION

This application claims the benefit of U.S. Provisional Patent Application Ser. No. 62/141,967 filed on Apr. 2, 2015.

### FIELD OF THE INVENTION

Embodiments of the present invention relate generally to inventory management, and more particularly to systems and methods for beverage inventory tracking.

### BACKGROUND OF THE INVENTION

United States Patent Application Publication No. 2007/02286068 to Schneider et al. discloses an alcoholic beverage management and inventory system comprising a beverage bottle categorizing system; a weighing system for determining total liquor dispensed; a system for computing total profits earned or lost; a system and method for tracking the distribution and location of all bottles at any selected location within a bar establishment; and, an integrated data synchronization, transfer, processing, storage and retrieval system that enables real-time inventory management of any selected number of related and/or unrelated bar establishments.

While Schneider et al. discloses a system intended for beverage management based on weight of dispensed liquor, improvements are desired.

### SUMMARY OF THE INVENTION

In accordance with an aspect, there is provided a beverage inventory system comprising a level sensing subsystem configured to interface with a beverage container and to produce one or more electronic signals based on a level of liquid within the container; and processing structure configured to receive the one or more electronic signals and to compute volume of liquid within the container based on a corresponding signal-volume relationship.

In an embodiment, the beverage inventory system comprises storage structure configured to electronically store the computed volume in association with historical volumes of the liquid within the container.

In an embodiment, the beverage inventory system comprises a container identification module configured to identify the beverage container thereby to select the corresponding signal-volume relationship.

According to another aspect, there is provided a method of determining a volume of liquid within a beverage container, the method comprising producing one or more electronic signals based on a level of liquid within the container; and computing the volume based on the one or more electronic signals and a signal-volume relationship corresponding to the container.

In an embodiment, the method comprises automatically determining the type of the beverage container; and selecting the corresponding signal-volume relationship based on the type.

According to another aspect, there is provided an apparatus for determining liquid level in a beverage container, the apparatus comprising a container interface dimensioned to interface with a mouth of the beverage container; level sensing structure associated with the container interface and configured to produce one or more electrical signals based on a level of liquid within the container; and a communications module configured to digitally transmit electronic messages corresponding to the one or more signals to a signal to volume conversion module.

Other aspects and advantages will become apparent from the following.

### BRIEF DESCRIPTION OF THE DRAWINGS

Embodiments of the invention will now be described with reference to the appended drawings in which:

FIG. 1 is a block diagram showing components in a beverage inventory system, according to an embodiment;

FIG. 2 is a top perspective view of a hardware subsystem of the beverage inventory system of FIG. 1; and

FIG. 3 is a top perspective view of the hardware subsystem of FIG. 2, with a portion of an outer housing removed to reveal components housed therein.

### DETAILED DESCRIPTION

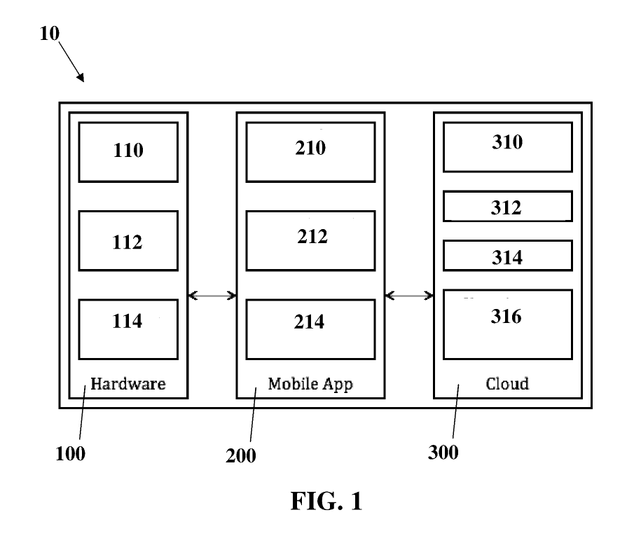

FIG. 1 includes a block diagram of components in a beverage inventory system 10 which, in this embodiment, includes a hardware subsystem 100, a mobile application subsystem 200, and a cloud subsystem 300.

Hardware subsystem 100 includes a level sensing module 110, processing structure 112, and a communications module 114. In this embodiment, level sensing module 110 is an ultrasonic distance sensor with a range of from about 60 millimetres to about 400 millimetres. The ultrasonic distance sensor emits one or more ultrasonic signals and receives the signals once they have been reflected back from a surface facing the ultrasonic sensor, such as a surface of liquid within a beverage container. The ultrasonic distance sensor produces a unique analog voltage signal depending upon how far the reflecting surface is from the level sensing module 110. Also in this embodiment, processing structure 112 is an Arduino™ microprocessor with onboard system memory that has been configured to direct operations on the hardware subsystem 100 and to coordinate communications to and from various components of the hardware subsystem 100 and other components of beverage inventory system 10, as will be described. In this embodiment, communications module 114 is a Bluetooth™ based transceiver that is physically integrated with the Arduino™ microprocessor on a common board as a package known as Arduino BT™. Amongst other functions, the communications module 114 wirelessly transmits digital messages encoding the unique voltage signal produced by the level sensing module 110.

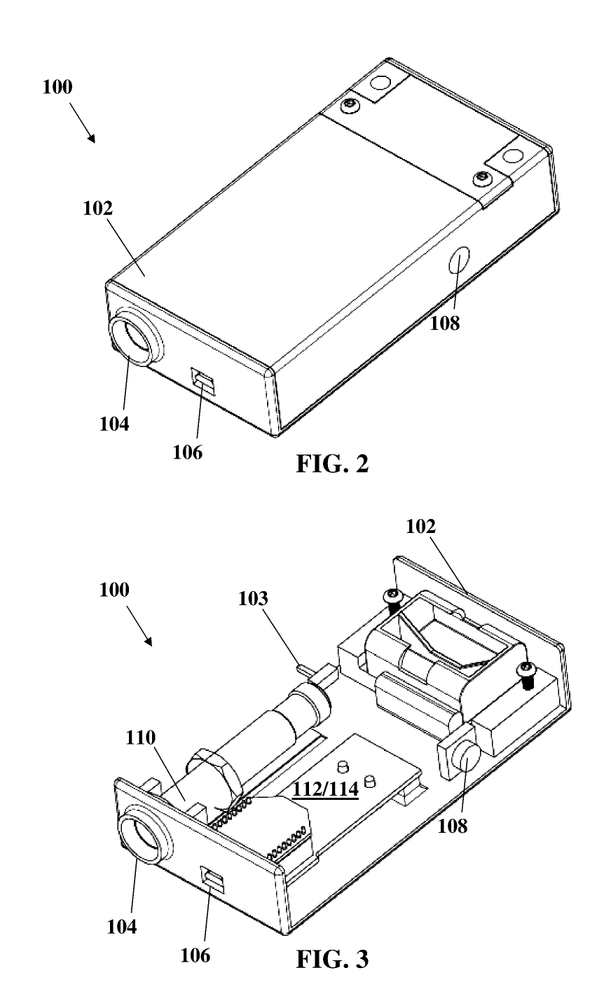

FIGS. 2 and 3 are top perspective views of the hardware subsystem 100, with an outer housing 102 in place (FIG. 2), and the outer housing removed (FIG. 3). Hardware subsystem 100 further includes a container mouth interface 104, an USB (Universal Serial Bus) communications port 106, and an activation switch 108. The hardware subsystem is powered by a Lithium Polymer battery in a known manner.

The container mouth interface 104 is configured to interface with a mouth of a beverage container, such as a bottle mouth, thereby to place the level sensing module 110 (see FIG. 3) in a position to sense the level of liquid within the container. More particularly, the level sensing module 110 is placed in a position to sense a reflective surface opposite the level sensing module 110 which, in the event that there is liquid within the beverage container, should be the surface of the liquid and otherwise should be the bottom inside surface of the beverage container itself.

In this embodiment, the container mouth interface is a hollow cylindrical protrusion extending from the end of the liquid level sensing module 110 through the housing 102, and having a diameter sized to enable the protrusion to just slightly receive the open mouth of a bottle. This configuration enables the hardware subsystem 100 to be selectively positioned with respect to a container such that the interior of the container mouth interface 104 can rest on the rim of the bottle during level sensing.

A power switch 103 is shown in FIG. 3, as is the ultrasonic distance sensor within the housing 102 that is, in this embodiment, employed as the level sensing module 110.

Mobile application subsystem 200 includes a container identification module 210, a liquid level detection module 212, and a communications module 214. In this embodiment, the mobile application subsystem 200 is based on a Smartphone platform such as the iOS operating system running on an iPhone™ provided by Apple Inc. of Mountainview, Calif. The Smartphone platform includes a camera operable to capture high-resolution digital images, processing structure and system memory for storing the images and program code for configuring the processing structure to perform various operating system-level functions as well as application-level functions, and to provide a communications platform upon which communications module 214 is operated.

The container identification module 210 configures the Smartphone to capture digital images of a unique barcode associated with a container and to process the digital images to extract the container identifier encoded within the unique barcode. The container identification module 210 further consults a container-type data structure in order to extract from the data structure a container type associated with the container identifier. The container type represents a particular configuration (storage volume and shape) of the container stored in a container reference library, as will be described. Many different containers may share a common container type, but a particular container may only have one container type.

In one example, a particular container being identified by container identification module 210 is a particular instance of a 750 millilitre (ml) Smirnoff™ vodka bottle. This particular vodka bottle may be one of five (5) 750 ml Smirnoff vodka bottles in a particular restaurant's inventory. In this example, each of these 5 particular vodka bottles will have been accorded a unique container identifier for uniquely identifying each bottle in the beverage inventory system 10. However, all will be associated with one common container type since they all have the same storage volume and shape. As such, a 500 ml Smirnoff™ vodka bottle will not share the same container type as the 750 ml one. Furthermore, a 750 ml Silent Sam™ vodka bottle will not share the same container type as the 750 ml Smirnoff™ vodka bottle, despite having the same volume, primarily because it does not share the same shape/proportions.

The liquid level detection module 212 configures the Smartphone to receive the container type from the container identification module 210, along with level data encoding a voltage level representing liquid level received from the hardware subsystem 100 via communications modules 114 and 214. With the container type and voltage level, the liquid level detection module 212 consults the container reference library stored in system memory to extract a liquid volume amount.

The container reference library is a pre-populated data structure that, for each container type, associates each of various voltage levels with a respective volume level. The container reference library serves as a conversion module that can convert a voltage level into a volume level for the container to which it pertains. The liquid volume amount is stored in the container reference library in units of millilitres (ml) in this embodiment. Various container types are represented within the container reference library, because liquid level alone is not sufficient for determining the volume with every type of container. For example, the neck of a given 750 ml vodka bottle may be shorter than the neck of other 750 ml vodka bottles, and longer than others. A longer-necked bottle would naturally cause there to be a longer distance between the level sensing module 110 and the top surface of any liquid contained in the bottle, than would a shorter-necked bottle. Similarly, the body of one 500 ml rum bottle could be slim and tall while the bottle of another 500 ml rum bottle is short and squat. Because of these potential differences, the container reference library is constructed containing, for each of several beverage producers' containers, voltage-versus-volume profiles mapping volumes to each of several voltages. It is this container reference library that is consulted by the liquid level detection module 212.

The container reference library that is used by mobile application subsystem 200 is a copy of the master container reference library 310 that is stored in cloud subsystem 300. The copy is synchronized periodically with additional or modified container voltage-volume profiles stored within the master container reference library 310 as containers are put into circulation or refinements to the profiles are made.

In this embodiment, master container reference library 310 stores polynomial voltage-volume curves for each container. Each curve is constructed by collecting several sample voltage-volume pairs from a respective container, and fitting a polynomial curve to the pairs. The raw voltage is a proxy for the liquid level in the container, such that actual liquid level does not have to be computed in order to determine, from the voltage, the liquid volume. In this way, any voltage received from hardware subsystem 100 for a given container (not just a previously-sampled voltage) can be matched to a corresponding volume by consulting the respective polynomial voltage-volume curve. The master container reference library 310 and its copies also contain the table pairing container identifier with container type (brand name, liquor name, liquor type, volume, price etc.), as well as data concerning the price per quantum of liquid (i.e., price per “shot”).

The cloud subsystem 300 also stores a point of sale register 112, which interfaces with the inventory and point of sale system for a given facility, such as for a given restaurant, and stores each upload of point of sale (“POS”) data. For example, for a given sale made in the facility, the POS data uploaded to the POS register 112 may include: brand name, liquor name, liquor type, volume of liquid sold, price, and time of sale.

The cloud subsystem 300 also stores a bar inventory register 114, which interfaces with the mobile subsystem 200 to receive uploads from the mobile subsystem 200 in the facility of bar inventory (“BI”) measurements to store each upload of the BI measurements. For example, for a given BI measurement made in the facility by level sensing and voltage-volume matching for a particular container, the BI data uploaded to the BI register 114 may include: container identifier, volume, and time of measurement. In this embodiment, the BI data may also include location data for capturing and registering the location of a particular container when its liquid level was measured, that is uploaded also.

The cloud subsystem 300 further stores a user access and data registry (“UADR”) 116, which contains the user profiles, respective level(s) of access, and user activity log for users authorized to use the beverage inventory system 10. The UADR 116 may be accessed for viewing and modification via a Web browser that is network connected to the cloud subsystem 300.

The cloud subsystem 300 also includes a recipe library (not shown), which stores types and volumes of subcomponent ingredients in association with a particular cocktail. The recipe library enables cloud subsystem 300 to receive POS data that includes a cocktail identifier, and to determine the expected amounts of component ingredients incorporated into the cocktail. In this way, the POS sale data does not have to include all data respecting the component ingredients for a given cocktail. For example, a Hurricane cocktail for a given restaurant or bar facility may include a proportion of Southern Comfort™ and a proportion of rum. In such a case, the POS sale data may specify that the beverage sold was a standard Hurricane of a particular volume, by providing a cocktail identifier and volume data. The recipe library enables cloud subsystem 300 to resolve the cocktail identifier for Hurricane into the individual volumes of the Southern Comfort™ and rum ingredients included in the cocktail, so that volumes of liquid subsequently measured in Southern Comfort™ and rum containers in the restaurant/bar can be reconciled with the cocktail that was sold there.

With the beverage inventory system 10 having been described, its operation by way of example will follow.

In order to identify a particular container, a user activates the mobile application subsystem 200 on the Smartphone by selecting a beverage inventory system application icon thereby to open the application. With the application having been opened, the user selects a “container scan” function from a set of options and directs the field of view of the Smartphone camera towards the barcode label of a container to be identified. While the barcode label is within the field of view of the camera, the user activates a capture function to capture a digital image of the barcode label. Upon activation of the capture button, the container scan function automatically supplies the digital image to a barcode scan application programming interface (“API”), which outputs a container identifier for the container. With the container identifier having been determined, the container reference equation of the container reference model corresponding to the type of container associated with the container identifier is loaded into system memory for subsequent use by the mobile application subsystem 200.

However, in the event that the container cannot be identified, a read error is generated and the user is automatically provided with the option of selecting a type of container from a pre-defined list of common containers. The pre-defined list is incorporated into the copy of the container reference library stored on the mobile application subsystem 100, and references a corresponding container reference model.

In order to track volumes of fluid in the containers, a user first activates the hardware subsystem 100 by turning to ON the power switch 103. Activation includes the communications subsystem 114 automatically re-establishing a pre-configured Bluetooth™ pairing with the communications subsystem 214. Once the pairing has been established, the processing structure 112 of the hardware subsystem 100 causes an LED (light emitting diode, not shown) to light thereby to indicate to the user that the hardware subsystem 100 is ready to be used. It will be noted that, at this juncture, the mobile application subsystem 200 has loaded a particular container reference model into memory as described above.

Once ready to be used for volume tracking, a user positions the hardware subsystem 100 so as to associate the container mouth interface 104 with the mouth of a container, thereby to align the level sensing structure 110 appropriately to face the surface of any liquid within the container. While the container mouth interface 104 is associated with the container in this way, the user then depresses activation switch 108 thereby causing the level sensing structure 110 to sense the distance of the surface of any liquid within the container from the container mouth interface 110. In this embodiment, the ultrasonic distance sensor level sensing structure 110 emits several discrete ultrasonic signals into the container and towards the surface of the liquid contained therein, and receives corresponding ultrasonic signals reflected back from the surface of the liquid. The ultrasonic distance sensor produces an analog voltage signal for each of the multiple ultrasonic signals that are emitted, reflected and received. The processing structure 112 receives each of the multiple analog voltage signals and digitally encodes the voltage signals into electronic messages for transmission via the Bluetooth™ connection to the mobile application subsystem 200.

Upon receipt of the multiple electronic messages from the hardware subsystem 100, the liquid level detection module 212 of mobile application subsystem 200 parses the individual voltage amounts out of the electronic messages and, for each voltage amount, determines a volume amount. Each volume amount is calculated by automatically entering the voltage amount into the container reference equation that has been loaded into system memory.

A mean volume amount is then calculated using the multiple volume amounts that have been calculated, and the mean volume amount is considered to be the volume of liquid in the container being measured.

With the volume of liquid in the container having been determined, the mobile application subsystem 200 transmits the volume in association with the container identifier to the cloud subsystem 300 using communications subsystem 214.

In order to track inventory of containers, a user activates the mobile subsystem 200 on the Smartphone by selecting the beverage inventory system application icon thereby opening the application. With the application having been opened, the user is provided with a location selection interface to select one of multiple service locations associated with the restaurant or bar. For example, depending on how the restaurant or bar is arranged, the user may select from one or more locations of bars within the facility, from one or more locations of storage rooms, and so forth. With the location having been selected, the user then selects an “inventory tracking” function from a set of options and either identifies the container at the particular selected location using the Smartphone camera, or selects a type of container from the pre-defined list, as described above in connection with container identification. If the container has not previously been entered into the beverage inventory system 10 for the restaurant/bar, the mobile application subsystem 200 signals the cloud subsystem 300 to increment the BI register with the new container and its container type thereby to add the container to the beverage inventory being tracked. If the container has been previously entered into the beverage inventory system 10, then in the event that the location within the restaurant/bar is to be changed, the BI register is updated with the change thereby to register an inventory “move”.

Upon initial configuration of the beverage inventory system 10, various locations within a particular bar/restaurant may be configured, and containers to be used initially in the various locations may be associated with respective locations. For example, in a nightclub having two upstairs bars and two downstairs bars, four (4) locations are configured, and various liquor and wine bottles associated with respective locations. When a new container enters the stock of the nightclub, a user can add the container to the beverage inventory system 10 or select the type of container as described above, and can also select one of the 4 locations with which the container is to be initially associated. When moving a container to a new location, the user can associate the container with the different location in the beverage inventory system 10.

The cloud subsystem 300 receives container inventory counts from the mobile application subsystem 200 and, in response, updates the BI register 314. Similarly, the cloud subsystem 300 receives container fluid volume data from the mobile application subsystem 200 and, in response, updates the BI register 314. The cloud subsystem 300 can be triggered to generate a variance report for a given time period by comparing the consumption of beverages, determined from differences in liquid volumes over the time period, to POS data in the POS register 316. In particular, a projected consumption is computed from the POS data for the time period and compared to the beverage consumption over the time period. Variances will arise in the event that the beverage volume over the time period drops more than would be indicated from the POS data for the time period, indicating that more beverage than has been sold has been consumed. Such variance reports can be very useful for identifying and correcting sources of waste.

A total inventory report reporting the latest status of inventory may be caused to be generated by cloud subsystem 300. The total inventory report can be used to help with planning of rates of inventory consumption and to establish inventory ordering and replenishment schedules. The cloud subsystem 300 can be configured to consult BI register 316 on a regular basis and to produce alerts for stakeholders such as suppliers and inventory managers when inventory levels drop below a threshold minimum amount.

Various analytics can be applied to the inventory and volume data being collected, on a global scale. For example, based on locations of particular bars/restaurants, the beverage inventory system 10 can be configured to provide inventory data on a geographical basis, so as to report on consumption of different products by geographic region, by brand, by supplier and by type of beverage.

Furthermore, based on analysis inputted time periods, the beverage inventory system 10 may be configured to report on consumption rates or on inventory turnover of various containers and conduct trend analysis on factors mentioned above. For example, based on consumption rates seasonal and non-seasonal inventory requirements can be forecasted.

The data collected as described herein may be employed for data aggregation and trend analysis, thereby to provide services such as historically-based predictive forecasting of inventory levels per restaurant, chain and geographic region based on what would be near real-time aggregated consumption data. As an example, the collected data could enable the system to predict particular liquors consumed on particular key dates at particular bars/restaurants, and popularity of the beverage across a chain or region.

Furthermore, the data collected could be processed for reports on loss control. For example, by comparing sales data to consumption data, the data could be used to provide time discretized variance data which would allow a bar/restaurant owner to determine time periods of maximum variance, so as to possibly identify member(s) of the staff who may be impacting profitability through relatively high or relatively low losses.

Although embodiments have been described with reference to the drawings, those of skill in the art will appreciate that variations and modifications may be made without departing from the spirit, scope and purpose of the invention as defined by the appended claims.

For example, while communications between hardware subsystem 100 and mobile application subsystem 200 has been described herein as based on Bluetooth™, a person having ordinary skill in this art will recognize that such communications may be facilitated using other communications technologies and/or protocols, such as Near Field Communications (NFC), WiFi, and ZigBee.

Furthermore, while the level sensing structure described in examples herein is a wireless type of level sensing structure, in particular an ultrasonic transceiver, other level sensing structures may be employed. It is preferable that such alternatives be wireless in nature, so as to keep the potential for introducing contaminates into containers to a minimum

In embodiments described herein, the beverage inventory system 10 has a single hardware subsystem 100. However, multiple hardware subsystems 100 may be incorporated into a beverage inventory system 10 so as, for example, to provide inventory and liquid volume tracking for multiple locations within a bar or restaurant.

In embodiments described herein, the hardware subsystem 100 and the mobile application subsystem 200 are discrete devices that communicate wirelessly with each other. However, in alternative embodiments, the functions of hardware subsystem 100 and mobile application subsystem 200 may be integrated such that the same physical device that is used to identify a container is also used to measure liquid level and determine corresponding liquid volumes in containers.

While embodiments described herein include a processing structure 112 and communications module 114 implemented as an integrated ArduinoBT™ microprocessor, other processing structure and communications module configurations, such as other Arduino™ variants, Intel Edison™, Raspberry Pi™, and Intel Galileo™, may be configured to function as described herein.

While embodiments described herein involve determining a voltage representing a level of liquid in a container, it will be understood that electronic signals of a different nature may be produced, such as current or another electromagnetic energy characteristic, for the purpose of communicating the liquid level and associating the characteristic with volume amounts based on the signals. The container reference library serving as a conversion module would be available to convert the level of the current or other type of signal into a volume level for the container to which it pertains.

What is claimed is:

1. A beverage inventory system comprising:
a level sensing subsystem configured to interface with a beverage container and to produce one or more electronic signals based on a level of liquid within the container; and
processing structure configured to receive the one or more electronic signals and to compute volume of liquid within the container based on a corresponding signal-volume relationship.

2. The beverage inventory system of claim 1, further comprising:
storage structure configured to electronically store the computed volume in association with historical volumes of the liquid within the container.

3. The beverage inventory system of claim 1, further comprising:
a container identification module configured to identify the beverage container thereby to select the corresponding signal-volume relationship.

4. A method of determining a volume of liquid within a beverage container, the method comprising:
producing one or more electronic signals based on a level of liquid within the container; and
computing the volume based on the one or more electronic signals and a signal-volume relationship corresponding to the container.

5. The method of claim 4, further comprising:
automatically determining the type of the beverage container; and
selecting the corresponding signal-volume relationship based on the type.

6. An apparatus for determining liquid level in a beverage container, the apparatus comprising:
a container interface dimensioned to interface with a mouth of the beverage container;
level sensing structure associated with the container interface and configured to produce one or more electronic signals based on a level of liquid within the container; and
a communications module configured to digitally transmit electronic messages corresponding to the one or more signals to a signal to volume conversion module.
